(19) United States
(12) Patent Application Publication
(10) Pub. No.: US 2024/0097329 A1
(43) Pub. Date: Mar. 21, 2024

(54) Antenna Arrangement with Amplitude Taper from Basis Polynomial for Antennas Distributed across Geometrical Shape

(71) Applicant: The United States of America, as represented by the Secretary of the Navy, San Diego, CA (US)

(72) Inventors: Kristopher Buchanan, San Diego, CA (US); Timi Adeyemi, San Diego, CA (US); Carlos F. Flores Molina, San Diego, CA (US); Sara Wheeland, San Diego, CA (US)

(21) Appl. No.: 17/946,846

(22) Filed: Sep. 16, 2022

(51) Int. Cl. H01Q 3/36; H01Q 1/34; H01Q 3/28

(52) U.S. Cl. CPC H01Q 3/36; H01Q 1/34; H01Q 3/28

(57) ABSTRACT

An antenna arrangement has radiation modes for antennas distributed across a geometrical shape, which is a bounded volume in three dimensions or a conformal surface of the bounded volume. A signal network couples between an electrical signal and the antennas with a taper along a selected dimension selected from the three dimensions of the bounded volume. The taper is specified by a selected dimension and a selected mode, which is selected from the radiation modes. Basis polynomials are indexed over the radiation modes and a specified basis polynomial is indexed at the selected mode. The specified basis polynomial gives the taper of an amplitude of the electrical signal at each of the antennas. An operating method determines a respective array factor for each distinct combination of one of the three dimensions and one of the radiation modes, and then selects the distinct combination with a desired array factor.

### FEDERALLY-SPONSORED RESEARCH AND DEVELOPMENT

The United States Government has ownership rights in this invention. Licensing and technical inquiries may be directed to the Office of Research and Technical Applications, Naval Information Warfare Center Pacific, Code 72120, San Diego, CA, 92152; voice (619) 553-5118; ssc_pac_t2@navy.mil. Reference Navy Case Number 112197.

### BACKGROUND OF THE INVENTION

An antenna array usually has a periodic structure. This periodic structure creates aliasing artifacts including grating lobes that must be carefully considered during design of the antenna array. Elimination of these artifacts generally puts limits on the periodic structure of the antenna array. There is a general need to reduce the constraints on the periodic structure of the antenna array to increase flexibility during design of the antenna array.

### SUMMARY

An antenna arrangement has radiation modes. The antenna arrangement includes antennas distributed across a geometrical shape, which is a bounded volume in three dimensions or a conformal surface of the bounded volume. The antenna arrangement includes a signal network for coupling between an electrical signal and the antennas with a taper along a selected dimension selected from the three dimensions of the bounded volume. The taper is specified by the selected dimension and a selected mode, which is selected from the radiation modes. Basis polynomials are indexed over the radiation modes and a specified basis polynomial of the basis polynomials is indexed at the selected mode of the radiation modes. The specified basis polynomial gives the taper of an amplitude of the electrical signal at each of the antennas.

A method operates an antenna arrangement with radiation modes across a geometrical shape. Antennas are distributed across the geometrical shape, which is a bounded volume in three dimensions or a conformal surface of the bounded volume. A respective array factor is determined for each distinct combination of one of the three dimensions of the bounded volume and one of the radiation modes. In response to the array factors for the distinct combinations, a selected dimension is selected from the three dimensions and a selected mode is selected from the radiation modes. Basis polynomials are indexed over the radiation modes and a specified basis polynomial of the basis polynomials is indexed at the selected mode of the radiation modes. A taper along the selected dimension is specified with the specified basis polynomial giving the taper of an amplitude of an electrical signal at each of the antennas for transmitting and/or receiving according to the array factor for the selected combination.

### BRIEF DESCRIPTION OF THE DRAWINGS

Throughout the several views, like elements are referenced using like references. The elements in the figures are not drawn to scale and some dimensions are exaggerated for clarity.

FIG. 1 is a perspective view of antennas distributed across a portion of a geometrical shape, which a conformal surface of a ship in accordance with an embodiment of the invention.

FIG. 2 is a perspective view of antennas carried on unpiloted aerial vehicles distributed across a portion of a geometrical shape, which a spherical bounded volume in accordance with an embodiment of the invention.

FIG. 3A-D are perspective views of geometrical shapes across which antennas of an antenna arrangement are distributed in accordance with embodiments of the invention.

FIG. 4 is a block diagram of an antenna arrangement including antennas and a signal network in accordance with an embodiment of the invention.

FIG. 5A is a perspective view of an amplitude taper in the z dimension from a third-order Chebyshev polynomial of the second kind U₃(z) for antennas distributed across a geometrical shape in accordance with an embodiment of the invention.

FIG. 5B is an array factor for the antenna arrangement with amplitude taper of FIG. 5A.

FIG. 6A is a perspective view of an amplitude taper in the y dimension from a fourth-order Chebyshev polynomial of the third kind V₄(y) for antennas distributed across a geometrical shape in accordance with an embodiment of the invention.

FIG. 6B is an array factor for the antenna arrangement with amplitude taper of FIG. 6A.

FIG. 7A is a perspective view of an amplitude taper in the y dimension from a tenth-order Chebyshev polynomial of the second kind U₁₀(y) for antennas distributed across a geometrical shape in accordance with an embodiment of the invention.

FIG. 7B is an array factor for the antenna arrangement with amplitude taper of FIG. 7A.

FIG. 8A is a perspective view of an amplitude taper in the y dimension from a ninth-order Chebyshev polynomial of the second kind U₉(y) with negation in the z dimension for antennas distributed across a geometrical shape in accordance with an embodiment of the invention.

FIG. 8B is an array factor for the antenna arrangement with amplitude taper of FIG. 8A.

FIG. 9 is a flow diagram of a method for operating an antenna arrangement with radiation modes across a geometrical shape in accordance with an embodiment of the invention.

### DETAILED DESCRIPTION OF EMBODIMENTS

The disclosed systems and methods below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other methods and systems described herein as will be understood by one of ordinary skill in the art unless otherwise stated specifically.

The inventors have discovered that non-periodic antenna arrays not only eliminate aliasing artifacts including grating lobes, but also increase flexibility of antenna placement. For example, a vehicle generally has sensors, indicators, and actuators disposed at specific areas on the surface area of the vehicle, and these instruments generally preclude placing antennas of an antenna array in these specific areas. These forbidden areas for antenna placement create constraints on the antenna array. The inventors have discovered that randomly placing antennas on the free surface area of the vehicle generally dramatically reduces aliasing artifacts including grating lobes, even when the average distance between the antennas would create such artifacts for an antenna array with a periodic structure having this average distance between the antennas.

The inventors have further discovered such an antenna array has fundamental radiation modes with respect to a given set of basis polynomials. Each fundamental radiation mode arises from a respective one of the basis polynomials. Each fundamental radiation mode provides a corresponding radiation pattern from the antenna array of the antenna arrangement.

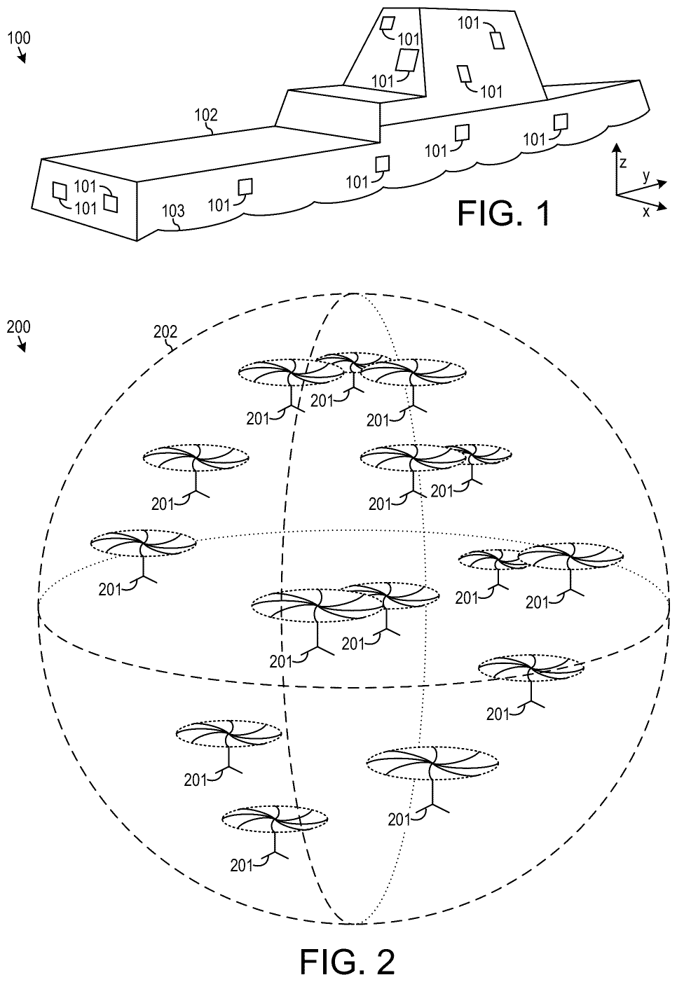

FIG. 1 is a perspective view 100 of antennas 101 distributed across a portion of a geometrical shape, which a conformal surface of a ship 102 in accordance with an embodiment of the invention. The antennas 101 of the antenna arrangement are randomly distributed across the available portion of the conformal surface of the bounded volume of the ship 102. The conformal surface of the ship 102 has many uses, including other instruments. The available portion of the conformal surface for the antennas 101 includes a free surface area of the ship 102 above a waterline 103 and otherwise available on the ship 102.

A coordinate system in the three dimensions of x, y, and z has coordinate x spanning from −1 at port to 1 at starboard of the ship 102, coordinate y spanning from −1 at aft to 1 at fore of the ship 102, and coordinate z spanning from −1 at the waterline 103 to 1 at an apex of the ship 102. An origin of the coordinate system is, for example, a center of mass of the ship 102, or at a midpoint between extremes of the ship 102 in each dimension, or an intersection between those xy, xz, and yz planes that each bisect the conformal surface area of the ship 102.

FIG. 2 is a perspective view 200 of antennas 201 carried on unpiloted aerial vehicles distributed across a portion of a geometrical shape, which a spherical bounded volume 202, in accordance with an embodiment of the invention. The antennas 201 of the antenna arrangement are randomly distributed across the interior portion of the bounded volume 202 surrounding a swarm of the unpiloted aerial vehicles. Thus, the portion of the bounded volume 202 includes a respective one of the antennas 201 carried on each of the unpiloted aerial vehicles.

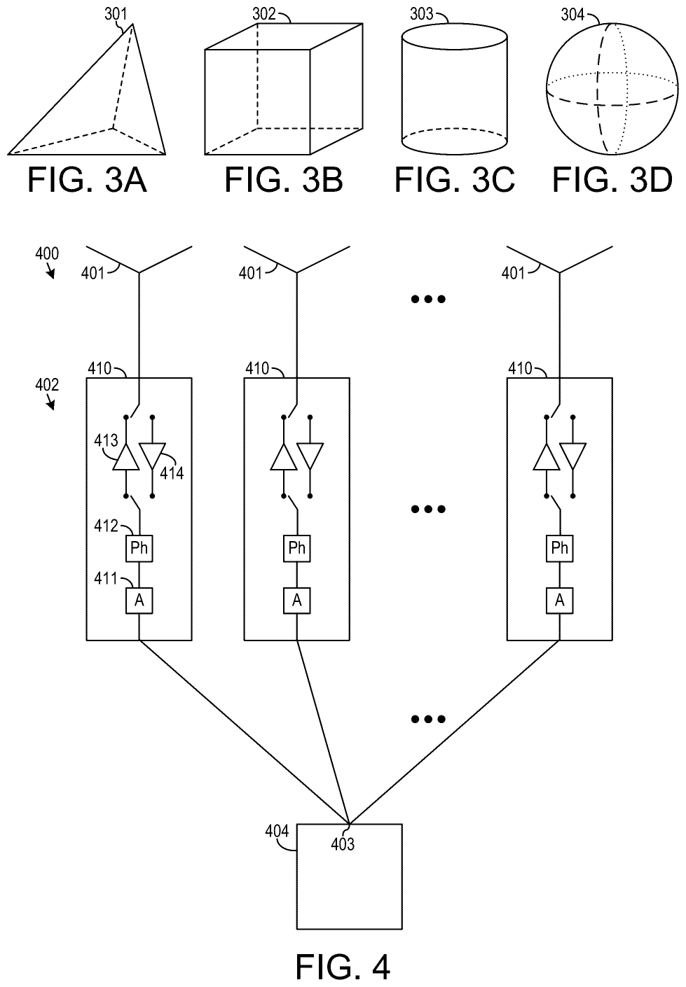

FIG. 3A-D are perspective views of geometrical shapes 301, 302, 303, and 304 across which antennas of an antenna arrangement are distributed in accordance with embodiments of the invention. The portion of the geometrical shape is selected from the group consisting of a hollow or solid pyramid 301, a hollow or solid cube 302, a hollow or solid truncated cylinder 303, and a hollow or solid sphere 304.

The antennas are randomly distributed across the portion of the geometrical shape that is all of the geometrical shape. For the solid shapes, the antennas are randomly distributed across an interior of the bounded volume of the geometrical shapes 301, 302, 303, and 304. For the hollow shapes, the antennas are randomly distributed across the conformal surface of the bounded volume of the geometrical shapes 301, 302, 303, and 304.

FIG. 4 is a block diagram of an antenna arrangement 400 including antennas 401 and a signal network 402 in accordance with an embodiment of the invention. The antenna arrangement 400 provides various radiation modes across a geometrical shape.

The signal network 402 couples between an electrical signal 403 from a signal source 404 and the antennas 401. The signal network includes respective transceivers 410 for the antennas 401. The signal network 402 is shown in FIG. 4 with a star topology directly coupling the electrical signal 403 to each of the transceivers 410; however, fan out from the signal source 404 to the transceivers 410 is typically accomplished with a branching tree, such as a branching binary tree. Alternatively, fan out is accomplished with a broadcast signal from the signal source 404 to the transceivers 410 together with accurate timekeeping at the transceivers 410.

Each of the transceivers 410 includes an amplitude adjuster 411, a phase adjuster 412, a power amplifier 413, and a low noise amplifier 414.

The amplitude adjuster 411 sets the amplitude of the taper of the electrical signal 403 at the antennas 401 from a specified basis polynomial. The taper is specified by a selected dimension and a selected mode selected from the radiation modes. The taper occurs along the selected dimension, which is selected from the three dimensions of the bounded volume containing the antennas 401. A set of basis polynomials are indexed over the radiation modes and the specified basis polynomial is indexed at the selected radiation mode. Preferably, the set of basis polynomials are indexed over integer radiation modes and collectively form an orthogonal basis, and the specified basis polynomial is indexed at the selected mode, which one of these integers. Thus, the specified basis polynomial gives the amplitude taper along the selected dimension of the electrical signal 403 at each of the antennas 401.

The phase adjuster 412 sets a phase of the electrical signal 403 at each of the antennas 401 for scanning a beam of the antenna arrangement 400. Preferably, the phase adjuster 412 sets phases at the antennas 401 so that the electromagnetic energy radiating to or from the antennas 401 undergoes constructive interference in the desired direction or directions.

During a transmit mode, each power amplifier 413 drives one of the antennas 401 from the electrical signal 403 having the amplitude from the amplitude adjuster 411 and the phase from the phase adjuster 412. Each of the transceivers 410 further includes a double-pole double-throw switch shown switched to the transmit mode. This switch is alternatively switched to the receive mode, during which each low noise amplifier 414 couples from one of the antennas 401 to the electrical signal 403 having the amplitude from the amplitude adjuster 411 and the phase from the phase adjuster 412.

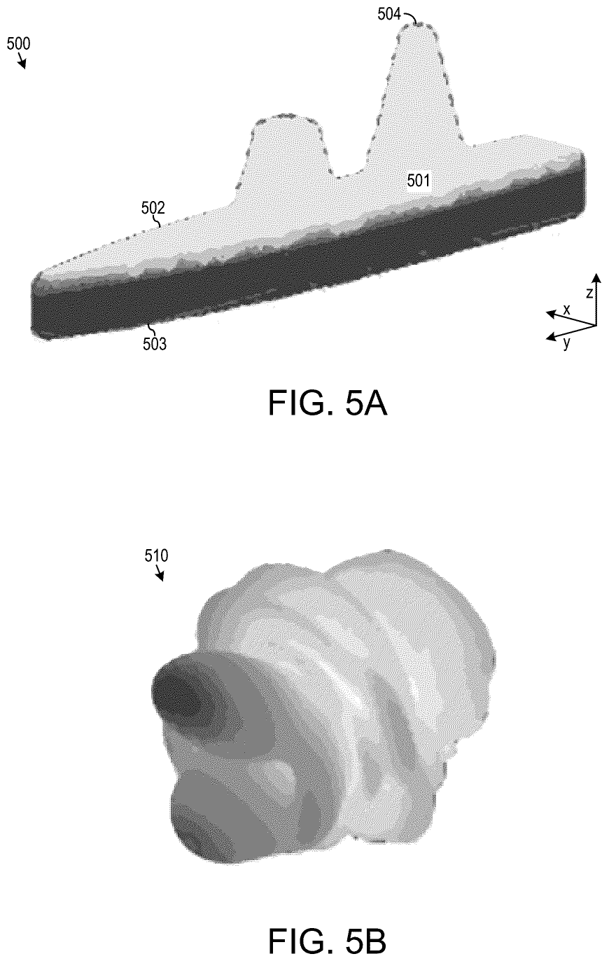

FIG. 5A is a perspective view 500 of an amplitude taper 501 in the z dimension from a third-order Chebyshev polynomial of the second kind U₃(z) for antennas distributed across a geometrical shape of the conformal surface of the bounded volume of a ship 502 in accordance with an embodiment of the invention. FIG. 5B is an array factor 510 for the antenna arrangement with amplitude taper 501 of FIG. 5A. Thus, with respect to the Chebyshev polynomials of the second kind, FIG. 5B shows the array factor 510 resulting when the selected dimension is the z dimension and the selected mode is 3 (third-order) yielding the amplitude taper 501 of FIG. 5A.

The darkest shade of the amplitude taper 501 toward the waterline 503 of the ship 502 corresponds to an amplitude taper 501 of −1, and the lightest shade of the amplitude taper 501 toward the apex 504 of the ship 502 corresponds to an amplitude taper 501 of +1. The shades in between the darkest and lightest shades of the amplitude taper 501 correspond to a fractional values between −1 and +1. The extreme values of −1 and +1 each correspond to a maximum magnitude of the taper 501, but with phase reversed between these two extreme values.

In FIG. 5A, the z dimension is scaled to span between a domain value of −1 at the extreme at the waterline 503 and a domain value of +1 at the extreme at the apex 504 of the ship 502. The value of the amplitude taper 501 at each point with coordinates (x, y, z) on the conformal surface of the ship 502 is proportional to the value of the third-order Chebyshev polynomial of the second kind U₃(z) evaluated at the value of the scaled z dimension of the point. Thus, the amplitude taper 501 at each of the antennas is proportional to a range value, in the range inclusively between −1 and 1, of the third-order Chebyshev polynomial of the second kind U₃(z) at a domain value, in the domain inclusively between −1 and 1, at which the antenna is disposed along the dimension z scaled to span between extremes of the bounded volume across the dimension z.

Again, FIG. 5B is an array factor 510 for the antenna arrangement with amplitude taper 501 of FIG. 5A. The darkest shade of the amplitude taper 501 corresponds to a gain of 0 dB, and the lightest shade corresponds to a gain of −30 dB. FIG. 5B shows the array factor 510 with a relatively high gain lobe elevated in the forward direction of the ship 502.

The array factor 510 is an expectation radiation pattern of the antenna arrangement in a far-field when, for each angular direction of the far-field, the signal network provides the amplitude taper 501 and a phase of the electrical signal at each of the antennas, with the phase causing fully constructive interference in the angular direction from all of the antennas, which are assumed to be omnidirectional antennas. When the antennas are not actually omnidirectional antennas, the expectation radiation pattern becomes a product of the array factor 510 and an element factor capturing the directional gain of the antennas.

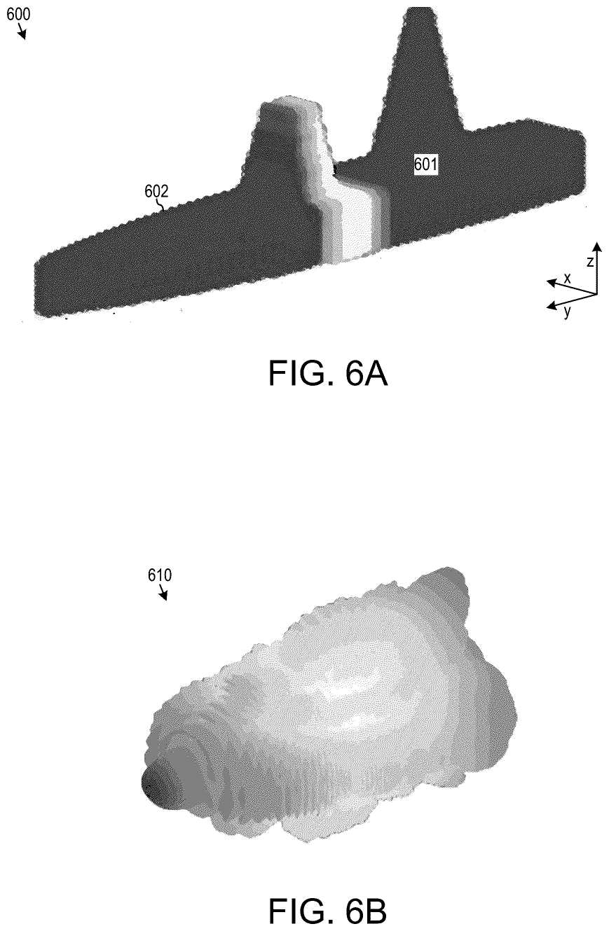

FIG. 6A is a perspective view 600 of an amplitude taper 601 in the y dimension from a fourth-order Chebyshev polynomial of the third kind V₄(y) for antennas distributed across a geometrical shape of the conformal surface of the bounded volume of a ship 602 in accordance with an embodiment of the invention. FIG. 6B is an array factor 610 for the antenna arrangement with amplitude taper 601 of FIG. 6A. FIG. 6B shows the array factor 610 with a relatively high gain lobe centered in the forward direction of the ship 602. Thus, with respect to the Chebyshev polynomials of the third kind, FIG. 6B shows the array factor 610 resulting when the selected dimension is the y dimension and the selected mode is 4 (fourth-order) yielding the amplitude taper 601 of FIG. 6A.

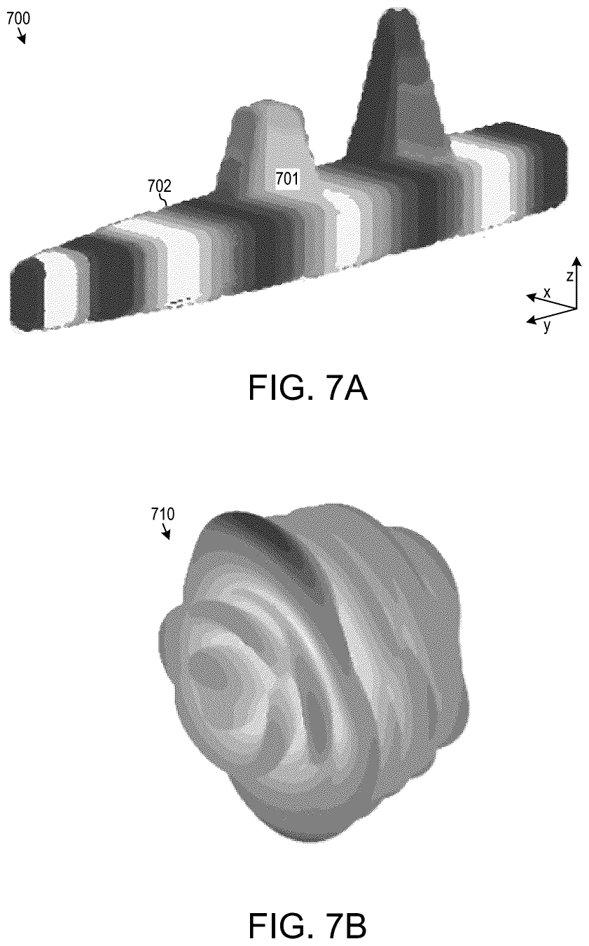

FIG. 7A is a perspective view 700 of an amplitude taper 701 in the y dimension from a tenth-order Chebyshev polynomial of the second kind U₁₀(y) for antennas distributed across a geometrical shape of a ship 702 in accordance with an embodiment of the invention. FIG. 7B is an array factor 710 for the antenna arrangement with amplitude taper 701 of FIG. 7A. With respect to the Chebyshev polynomials of the second kind, FIG. 7B shows the array factor 710 resulting when the selected dimension is the y dimension and the selected mode is 10 (tenth-order) yielding the amplitude taper 701 of FIG. 7A.

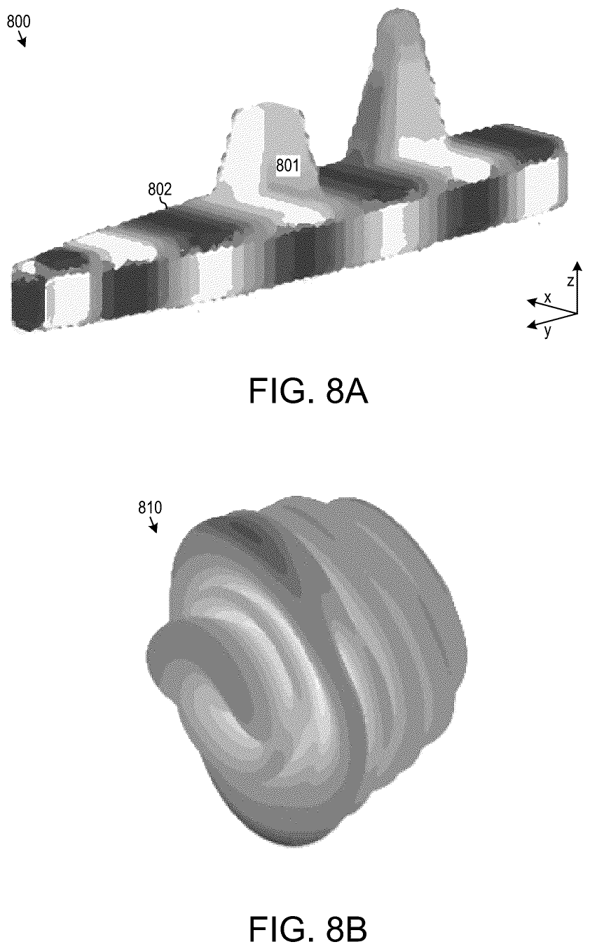

FIG. 8A is a perspective view 800 of an amplitude taper 801 in the y dimension from a ninth-order Chebyshev polynomial of the second kind U₉(y) with negation in the z dimension for antennas distributed across a geometrical shape of a ship 802 in accordance with an embodiment of the invention. FIG. 8B is an array factor 810 for the antenna arrangement with amplitude taper 801 of FIG. 8A.

In addition to showing the amplitude taper 801 selected along the y dimension, FIG. 8A shows selection of the z dimension as a second dimension specifying the amplitude taper 801. The amplitude taper 801 is negated between positive and negative sides of the ship 802 along the second selected dimension z to reverse the phase between the positive and negative sides of the ship 802.

With respect to the Chebyshev polynomials of the second kind, FIG. 8B shows the array factor 810 resulting when the selected dimension for the taper is the y dimension and the selected mode is 9 (ninth-order) yielding the amplitude taper 801 with negation in the selected z dimension of FIG. 8A.

More generally, the first selected dimension specifies the direction of the amplitude taper and the second selected dimension specifies the direction of the negation of the amplitude taper. The second selected dimension is another one of the three dimensions of x, y, and z besides the first selected dimension. The signal network gives the amplitude and a phase of the electrical signal at each of the antennas. The amplitude from the specified basis polynomial is negated between positive and negative sides of the geometrical shape along the second selected dimension to reverse the phase between the positive and negative sides of the geometrical shape. This typically adds some asymmetry to the array factor 810 as shown in FIG. 8B.

There exists a variety of basis polynomials and a variety of orthogonal basis polynomials. Examples include the Chebyshev polynomials including Chebyshev polynomials of the first kind Tn(x), Chebyshev polynomials of the second kind Un(x), Chebyshev polynomials of the third kind Vn(x), and Chebyshev polynomials of the fourth kind Wn(x). Note that the abstract variable x in the above Chebyshev polynomials is selected to be any one of the three physical dimensions of x, y, and z in embodiments of the invention.

With respect to a particular set of orthogonal basis polynomials, because the particular orthogonal basis polynomials form an orthogonal basis, any functional mapping from a domain to a range is achievable as a sum of an infinite series of the orthogonal basis polynomial so long as the functional mapping is well-behaved. Here, well-behaved includes, but is not limited to, a continuous functional mapping. Basis polynomials include orthogonal basis polynomials indexed over non-negative integers that collectively form a basis for functional mapping from a domain to a range. Preferably, both the domain and the range are each limited to values inclusively between −1 and +1, but appropriate scaling supports other domains and ranges in embodiments of the invention.

Embodiment of the invention predominately concern the fundamental radiation modes with respect to a particular set of basis polynomials. For a set of basis polynomials indexed over non-negative integers, each fundamental radiation mode is the functional mapping from a domain to a range given by a specific basis polynomial indexed at a particular non-negative integer. FIG. 5A, FIG. 6A, FIG. 7A, and FIG. 8A show the amplitude tapers 501, 601, 701, and 801 resulting when the radiation mode is integers 3, 4, 10, and 9, respectively, for various Chebyshev orthogonal basis polynomials.

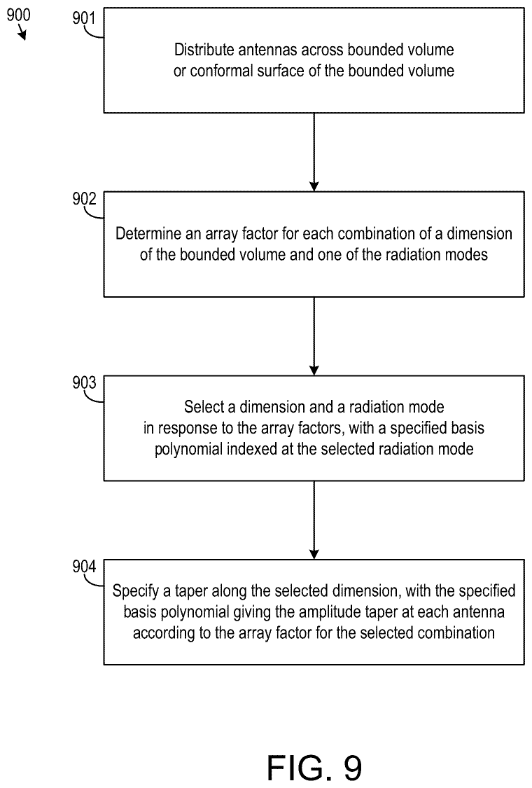

FIG. 9 is a flow diagram 900 of a method for operating an antenna arrangement with radiation modes across a geometrical shape in accordance with an embodiment of the invention.

At step 901, antennas are distributed across a portion of the geometrical shape, which is a bounded volume in three dimensions or a conformal surface of the bounded volume.

At step 902, a respective array factor is determined for each distinct combination of one of the three dimensions x, y, and z of the bounded volume and one of the available radiation modes. Basis polynomials, such as Chebyshev polynomials of the third kind, are indexed over the radiation modes.

At step 903, a selected dimension is selected from the three dimensions and a selected mode is selected from the radiation modes in response to the array factors for the distinct combinations. For example, one of the array factors has a high-gain lobe is a desired direction, so the selected dimension and the selected mode are selected from the distinct combination having the desired array factor with the high-gain lobe. A specified basis polynomial of the basis polynomials is indexed at the selected mode of the radiation modes.

At step 904, a taper is specified along the selected dimension with the specified basis polynomial giving the taper of an amplitude of an electrical signal at each of the antennas for transmitting and/or receiving according to the array factor for the combination selected in step 903.

In summary, FIG. 5B, FIG. 6B, FIG. 7B, and FIG. 8B show possible array factors 510, 610, 710, and 810, and if one of these array factors has a desirable gain pattern, then the corresponding dimension and radiation mode are selected at step 903, and at step 904 the selected dimension and the selected radiation mode yield the corresponding amplitude taper 501, 601, 701, or 801 shown in FIG. 5A, FIG. 6A, FIG. 7A, or FIG. 8A. Optionally, a second dimension is selected specifying a direction of negation of the corresponding amplitude taper 801 as shown in FIG. 8A.

In general, the antenna arrangement possesses a respective array factor beyond the bounded volume encompassing the antennas for each combination of one of the three dimensions of the bounded volume and one of the radiation modes. The respective array factor for each combination is an expectation radiation pattern of the antenna arrangement in a far-field when, for each angular direction of the far-field, the signal network provides the amplitude taper and a phase of the electrical signal at each of the antennas, with the phase causing fully constructive interference in the angular direction from all of the antennas, which are assumed to be omnidirectional antennas. When the antennas are not actually omnidirectional antennas, the expectation radiation pattern becomes a product of the array factor and an element factor capturing the directional gain of the antennas.

In one embodiment, the selected dimension and the selected mode are dynamically selected to achieve the respective array factor for a particular combination of the selected dimension and the selected mode. For example, FIG. 5B shows a relatively high gain lobe elevated in the forward direction of the ship 502. If scanning in the direction of this high gain lobe or in directions within this high gain lobe is desired, then the z dimension and radiation mode 3 of the amplitude taper 501 are selected. Typically, the higher degree basis polynomials have more directional array factors. Thus, when basis polynomial are indexed over non-negative integers, the selected mode indexing the specified basis polynomial is typically an integer greater than or equal to two, and preferably greater than or equal to three.

The selected dimension is selected as one of the three dimensions of x, y, and z. The specified basis polynomial indexed at the selected mode gives the taper of the amplitude of the electrical signal at each antenna when the specified basis polynomial is evaluated at a domain value along the selected dimension where the antenna is disposed on the geometrical shape, which is a bounded volume in three dimensions or a conformal surface of the bounded volume.

A set of basis polynomials are indexed over the radiation modes. Frequently, these radiation modes are integers greater than or equal to zero that index through the basis polynomials. In one embodiment, the basis polynomials are the Chebyshev polynomials of the third kind Vn(x). The specified basis polynomial indexed at the selected mode, i, of the radiation modes, n≥0, is Vi(x). The amplitude of the taper at each antenna of the antennas is proportional to Vi(x) at a domain value, x, at which the antenna is disposed along the selected dimension scaled to span between extremes of the bounded volume across the selected dimension. Note that the abstract variable x in the above Chebyshev polynomials is selected to be any one of the three physical dimensions of x, y, and z in embodiments of the invention.

From the above description of Antenna Arrangement with Amplitude Taper from a Basis Polynomial for Antennas Distributed across a Geometrical Shape, it is manifest that various techniques may be used for implementing the concepts of system 400 and method 900 without departing from the scope of the claims. The described embodiments are to be considered in all respects as illustrative and not restrictive. The system 400 or method 900 disclosed herein may be practiced in the absence of any element that is not specifically claimed and/or disclosed herein. It should also be understood that each of system 400 or method 900 is not limited to the particular embodiments described herein, but is capable of many embodiments without departing from the scope of the claims.

We claim:

1. An antenna arrangement with a plurality of radiation modes across a geometrical shape comprising:
a plurality of antennas distributed across a portion of the geometrical shape, which is a bounded volume in three dimensions or a conformal surface of the bounded volume; and
a signal network for coupling between an electrical signal and the antennas with a taper along a selected dimension selected from the three dimensions of the bounded volume, the taper specified by the selected dimension and a selected mode selected from the radiation modes, wherein a plurality of basis polynomials are indexed over the radiation modes and a specified basis polynomial of the basis polynomials is indexed at the selected mode of the radiation modes, and the specified basis polynomial gives the taper of an amplitude of the electrical signal at each of the antennas.

2. The antenna arrangement of claim 1, wherein:
the antenna arrangement possesses a respective array factor beyond the bounded volume for each combination of one of the three dimensions and one of the radiation modes; and
the selected dimension and the selected mode are dynamically selected to achieve the respective array factor for the combination of the selected dimension and the selected mode.

3. The antenna arrangement of claim 2, wherein the respective array factor for the combination is an expectation radiation pattern of the antenna arrangement in a far-field when, for each angular direction of the far-field, the signal network provides the amplitude and a phase of the electrical signal at each of the antennas, with the phase causing fully constructive interference in the angular direction from all of the antennas.

4. The antenna arrangement of claim 3, wherein the amplitude of the taper at each antenna of the antennas is proportional to a range value of the specified basis polynomial at a domain value at which the antenna is disposed along the selected dimension within a span between extremes of the bounded volume across the selected dimension.

5. The antenna arrangement of claim 1, wherein the amplitude of the taper at each antenna of the antennas is proportional to a range value of the specified basis polynomial at a domain value at which the antenna is disposed along the selected dimension within a span between extremes of the bounded volume across the selected dimension.

6. The antenna arrangement of claim 1, wherein:
the basis polynomials are indexed over the radiation modes, which are integers greater than or equal to zero; and
the specified basis polynomial is indexed at the selected mode, which one of the integers greater than or equal to two.

7. The antenna arrangement of claim 1, wherein the basis polynomials indexed over the radiation modes collectively form an orthogonal basis for functional mapping from a domain to a range.

8. The antenna arrangement of claim 7, wherein the amplitude of the taper at each antenna of the antennas is proportional to a range value, in the range inclusively between −1 and 1, of the specified basis polynomial at a domain value, in the domain inclusively between −1 and 1, at which the antenna is disposed along the selected dimension scaled to span between extremes of the bounded volume across the selected dimension.

9. The antenna arrangement of claim 1, wherein the basis polynomials are Chebyshev polynomials selected from the group consisting of Chebyshev polynomials of the first kind Tn(x), Chebyshev polynomials of the second kind Un(x), Chebyshev polynomials of the third kind Vn(x), and Chebyshev polynomials of the fourth kind Wn(x).

10. The antenna arrangement of claim 9, wherein:
the basis polynomials are the Chebyshev polynomials of the third kind Vn(x);
the specified basis polynomial indexed at the selected mode, i, of the radiation modes, n≥0, is Vi(x); and
the amplitude of the taper at each antenna of the antennas is proportional to Vi(x) at a domain value, x, at which the antenna is disposed along the selected dimension scaled to span between extremes of the bounded volume across the selected dimension.

11. The antenna arrangement of claim 1, wherein:
the signal network includes, for each antenna of the antennas, a respective transceiver, which includes an amplitude adjuster and a phase adjuster;
the amplitude adjuster for setting the amplitude of the taper of the electrical signal at the antenna from the specified basis polynomial; and
the phase adjuster for setting a phase of the electrical signal at the antenna for scanning a beam of the antenna arrangement.

12. The antenna arrangement of claim 11, wherein:
the respective transceiver for each antenna of the antennas further includes a power amplifier and a low noise amplifier;
the power amplifier for driving the antenna from the electrical signal having the amplitude from the amplitude adjuster and the phase from the phase adjuster during a transmit mode; and
the low noise amplifier for coupling from the antenna to the electrical signal having the amplitude from the amplitude adjuster and the phase from the phase adjuster during a receive mode.

13. The antenna arrangement of claim 1, wherein the portion of the geometrical shape is selected from the group consisting of a hollow pyramid, a solid pyramid, a hollow cube, a solid cube, a hollow truncated cylinder, a solid truncated cylinder, a hollow spherical shell, and a solid sphere.

14. The antenna arrangement of claim 1, wherein the antennas are randomly distributed across the portion of the geometrical shape that is all of the geometrical shape, which is the bounded volume or the conformal surface.

15. The antenna arrangement of claim 1, wherein:
the antennas are randomly distributed across the portion of the geometrical shape, which is the bounded volume surrounding a swarm of unpiloted aerial vehicles; and
the portion of the bounded volume includes a respective one of the antennas carried on each of the unpiloted aerial vehicles.

16. The antenna arrangement of claim 1, wherein:
the antennas are randomly distributed across the portion of the geometrical shape, which is the conformal surface of the bounded volume of a ship; and
the portion of the conformal surface the ship includes a free surface area of the ship above a waterline and otherwise available on the ship.

17. The antenna arrangement of claim 16, wherein:
a coordinate system in the three dimensions of x, y, and z has coordinate x spanning from −1 at port to 1 at starboard of the ship, coordinate y spanning from −1 at aft to 1 at fore of the ship, and coordinate z spanning from −1 at the waterline to 1 at an apex of the ship;
the selected dimension is selected as one of the three dimensions of x, y, and z; and
the specified basis polynomial indexed at the selected mode gives the taper of the amplitude of the electrical signal at each antenna of the antennas when the specified basis polynomial is evaluated at a domain value along the selected dimension where the antenna is disposed on the portion of the conformal surface of the ship.

18. The antenna arrangement of claim 17, wherein:
the selected dimension is a first selected dimension and a second selected dimension is another one of the three dimensions of x, y, and z besides the first selected dimension; and
the signal network gives the amplitude and a phase of the electrical signal at each of the antennas, wherein the amplitude from the specified basis polynomial is negated between positive and negative sides of the ship along the second selected dimension to reverse the phase between the positive and negative sides of the ship.

19. A method for operating the antenna arrangement of claim 1, comprising:
distributing the antennas across the portion of the geometrical shape, which is the bounded volume in the three dimensions or the conformal surface of the bounded volume;
determining a respective one of a plurality array factors for each combination of a plurality of distinct combinations of one of the three dimensions of the bounded volume and one of the radiation modes;
selecting the selected dimension from the three dimensions and the selected mode from the radiation modes in response to the array factors for the distinct combinations, wherein the basis polynomials are indexed over the radiation modes and the specified basis polynomial of the basis polynomials is indexed at the selected mode of the radiation modes; and
specifying the taper along the selected dimension with the specified basis polynomial giving the taper of the amplitude of the electrical signal at each of the antennas for transmitting and/or receiving according to the respective one of the array factors for the combination of the selected dimension and the selected mode.

20. A method for operating an antenna arrangement with a plurality of radiation modes across a geometrical shape comprising:
distributing a plurality of antennas across a portion of the geometrical shape, which is a bounded volume in three dimensions or a conformal surface of the bounded volume;
determining a respective one of a plurality array factors for each combination of a plurality of distinct combinations of one of the three dimensions of the bounded volume and one of the radiation modes;
selecting a selected dimension from the three dimensions and a selected mode from the radiation modes in response to the array factors for the distinct combinations, wherein a plurality of basis polynomials are indexed over the radiation modes and a specified basis polynomial of the basis polynomials is indexed at the selected mode of the radiation modes; and
specifying a taper along the selected dimension with the specified basis polynomial giving the taper of an amplitude of an electrical signal at each of the antennas for transmitting and/or receiving according to the respective one of the array factors for the combination of the selected dimension and the selected mode.
